(19) United States
(12) Patent Application Publication
(10) Pub. No.: US 2003/0046090 A1
(43) Pub. Date: Mar. 6, 2003

(54) Personalized health video system

(76) Inventor: Eric Brown, Newport Beach, CA (US)

Correspondence Address: Patent Law & Venture Group, Suite K-105, 3151 Airway Ave., Costa Mesa, CA, 92626, US

(21) Appl. No.: 09/816,701

(22) Filed: Aug. 27, 2001

(51) Int. Cl. G06F 17/60

(52) U.S. Cl. 705/1

(57) ABSTRACT

A personalized health video system, method and apparatus which comprises the components of: a personal data collecting device, Internet enablement device, information system, video serving device, server operating system, user operating system, graphical creation device, viewing device, audio device, relationship generating device, script generating device, charts generating device, chart reviewing device, and video library device; the components arranged and interconnected and enabled in an operating personalized health video system.

### RELATED APPLICATIONS

| | | | |
|---|---|---|---|
| Provisional | Healthcare Signal | 60/0705 | Jan. 06, 1998 |
| Application | Telemetry System | 21 | |
| Provisional | Medical Device | 60/0716 | Jan. 16, 1998 |
| Application | Telemetry Accessory | 23 | |
| Provisional | Wound Management | 60/0887 | Jun. 10, 1998 |
| Application | Medical Telemetry | 27 | |
| | System | | |
| Patent Application | Apparatus and Method | 09/2251 | Jan. 04, 1999 |
| | for Improving Patient | 73 | |
| | Compliance with a | | |
| | Medical Program | | |
| Patent Application | Method for Improving | 09/2666 | Mar. 11, 1999 |
| | Patient Compliance with | 47 | |
| | a Medical Program | | |
| Continuation-in- | Method for Improving | 09/3222 | May 28, 1999 |
| Part | Patient Compliance with | 09 | |
| | a Medical Program | | |

### BACKGROUND OF THE INVENTION

1. Field of the Invention

This invention relates generally to interactive health care information systems and more particularly to a health care information system using wide area network communications and video presentations for improved health maintenance to a large subscriber base.

2. Description of Related Art

The following art defines the present state of this field:

Kutzik et al, U.S. Pat. No. 5,692,215 describes a system that provides for monitoring a user in a user living area. The system includes a system controller and an activity detection subsystem. The activity detection subsystem monitors a daily living activity of the user and provides information representative of the daily living activity to the system controller. The system controller includes a control circuit which generates a control signal in response to the daily living activity information obtained by the activity detection subsystem. Control information from the system controller is applied by way of a control information communication channel both to the activity detection subsystem and to a remote monitoring site. The activity detection subsystem may be system for determining the movement of the user around the home, medication compliance by the user, problems with usage for stoves or other potentially dangerous appliances, and selected auxiliary appliances.

Lipscher, U.S. Pat. No. 4,082,084 describes a portable diagnostic device, particularly for medical field-examinations comprising a case-like housing in which replaceable electronic examining units are arranged serving for the examination of different physiological functions and/or conditions. The housing comprises an electronic power supply feeding each of the electronic examining units, a common display receiving the output signals of the examining units and electrical connectors providing electrical connections between the housing and each of the examining units. The inner room of the housing is divided into two separate parts, the first of which is arranged in a modular system and accommodates slide-in examining units, while the second part serves to accommodate the accessory means required for the examinations.

Fu, U.S. Pat. No. 4,803,625 provides for a personal health monitor which includes sensors for measuring patient weight, temperature, blood pressure, and ECG waveform. The monitor is coupled to a central unit via modems and includes a computer which is programmed to prompt a patient to take prescribed medication at prescribed times, to use the sensor to measure prescribed health parameters, and to supply answers to selected questions. Medication compliance information, test results, and patient answers are compiled in a composite log which is automatically transmitted to the central unit. The computer is also programmed automatically to disconnect the monitor from an alternating current power source and to rely on internal battery power during certain periods of patient monitor interaction, such as during use of the ECG module. In this way, danger to the patient and complexity of the ECG module are minimized. The computer is also programmed to compare measured test information with predetermined expected values, and in the event of a discrepancy, to collect additional information from the patient to assist trained personnel at the central unit in interpreting the composite log. The computer is also programmed to alert the central unit promptly in the event one or more measured parameters falls outside of a prescribed normal range. The normal range for a given parameter is made to vary in accordance with the measured value of one or more other parameters in order to reduce the incidence of false alarms.

Bornn et al., U.S. Pat. No. 4,827,943 provides a link between the caregiver and the subject being monitored which utilizes an intermediate base station with redundant signal paths between the base station and the caregiver. The caregiver wears a unit which receives signals from the base station. Signals from the base station provide information about the subject being monitored and provides signals for use in determining whether the caregiver remains within the range of the base station. The unit worn by the subject being monitored can include diagnostic circuitry for evaluating signals received from sensors to transmit an alarm signal to the base stations when the subject being monitored is in need of assistance. A range monitoring system is provided which alerts the subject being monitored as well as the caregiver whenever the subject being monitored moves outside the range of the base station.

Kaufman, U.S. Pat. No. 4,933,873 describes an interactive patient assistance device which houses both pre-selected doses of medication and a physical testing device. Both medication and the testing device are normally retained within separate compartments within the device away from access by the patient. The device keeps track of medication and diagnostic testing schedules. The device is also capable of receiving and interpreting verbal commands of the patient. The device makes a pre-selected dose of medication available to the patient in response to either the medication schedule or the receipt of a verbal command by the patient. Likewise, the testing device is made available to the patient in response either to the testing schedule or the receipt of a verbal command from the patient.

Treatch, U.S. Pat. No. 5,007,429 describes a user interface for directing the programming of operating parameters for patient blood pressure testing into and downloading blood pressure data from ambulatory patient blood pressure monitoring units. The user interface operates on a system comprising a plurality of microprocessor based, ambulatory blood pressure measuring patient units, an office control unit, and a data processing center, typically accessed over telephone lines. An office control unit is used to program patient units with test regimens for specific patients. The control units are also used to download data from the patient units and to transfer the data, along with patient identifying data, to the central data processing facility. The office control unit includes local memory which stores various interface routines, a microprocessor for executing the routines, a 12-character keypad allowing input of integers and a display for displaying prompts to the user. Upon initial power up of the control unit, and operator using the control unit is prompted through a start up sequence and a menu selection sequence to carry out the desired functions of the system. All selections are made, and all operating parameters are entered, through a telephone like keypad. The display indicates to the user which parameter entry of which is called for and which menu items are available for selection. During transfer of data to the central processing facility, additional prompts may be given to the operator by voice over the telephone handset.

Blomquist, U.S. Pat. No. 5,338,157 describes an invention relating to systems and methods for communicating with ambulatory medical devices, such as drug delivery devices, both locally and remotely. In one embodiment, a caregiver drug pump communicates with a remote patient drug pump for data gathering, trouble shooting, and operational program changes. The caregiver drug pump is at least substantially identical in configuration to the patient drug pump. The caregiver drub pump transmits caregiver key input signals to the remote patient drug pump. The patient drug pump receives the key input signals, accesses a desired program, and transmits information for display on the display of the caregiver drug pump. In another embodiment, a computer is provided for communicating locally and/or remotely with a drug pump. The computer may include a display with an image of a pump. The computer may be operated through the use of a mouse or touch screen with respect to the image of the pump, to simulate use of the pump while using the personal computer. The computer may also be used as a training aid for training a caregiver and/or patient how to use the drug pump.

Maestre, U.S. Pat. No. 5,347,453 describes a portable programmable medication device for aiding in the administration of medication or pharmaceuticals in accordance with a prescribed medication dosage schedule. In a first illustrative embodiment, the programmable medication alarm device is manually programmed with data representative of a prescribed medication dosage schedule specifying a prescribed administration time, dosage amount, administration route, and medication instructions for each medication dosage to be administered to the patient. In response to the time occurrence of each programmed administration time, and audible dosage alarm signal is generated and graphical representations of the prescribed administration time, dosage amount, administration route and medication instructions are visually displayed in predefined visual display fields. In a second illustrative embodiment, the portable medication alarm device is programmed by loading the prescribed dosage schedule data from a computer system, into the memory of the medication alarm device, using an automated data communication process. Also disclosed is a medication container holder which attaches the programmed medication alarm device to a conventional medication container, such as an eye-drop dispenser bottle, nasal-spray canister or pill bottle, without interfering with the operation thereof.

Stutman, U.S. Pat. No. 5,416,695 describes a medical alert system which enables an authorized user, such as a doctor, to remotely set selection and limit parameters pertaining to specific medical and geodetic information of an ambulatory patient and thereafter received updates of that information over a wireless communication network when the parameters have been met. A telemetry device attached to the patient provides an inbound stream of medical and geodetic information to a host computer, which is configured to exact selected portions of that information in response to the parameters provided by a remote processing device via a communications network. Upon completion of the latter process, the host computer transfers the extracted information to the remote processing device over the network, thereby informing the doctor of a medical situation.

Maestre, U.S. Pat. No. 5,495,961 describes a portable programmable medication alarm device for aiding in the administration of medication or pharmaceuticals in accordance with a prescribed medication dosage schedule. In a first illustrative embodiment, the programmable medication alarm device is manually programmed with data representative of a prescribed medication dosage schedule specifying a prescribed administration time, dosage amount, administration route, and medication instructions for each medication dosage to be administered to the patient. In response to the timed occurrence of each programmed administration time, an audible dosage alarm signal is generated and graphical representations of the prescribed administration time, dosage amount, administration route, and medication instructions are visually displayed in predefined visual display fields. In a second illustrative embodiment, the portable medication alarm device is programmed by loading the prescribed dosage schedule data from a computer system, into the memory of the medication alarm device, using an automated data communication process. Also disclosed is a medication container holder which attaches the programmed medication alarm device to a conventional medication container, such as an eye-drop dispenser bottle, nasal-spray canister or pill bottle, without interfering with the operation thereof.

Vasko, U.S. Pat. No. 5,573,506 describes a remotely programmable infusion pump with interactive voice response via touch-tone phone (i.e., voice mail system in IV pump). The remotely programmable infusion system also comprises a voice storage unit for storing the voice signal. The remotely programmable infusion system further comprises a processor, coupled to the remote communication port, to the voice storage unit, and to the memory, for accessing the voice signal from the voice storage unit and the programmable protocol from the memory, and for processing the programmable protocol in response to receiving the remote programming signal.

Kurtenbach, U.S. Pat. No. 5,582,323 describes a medication dispensing and monitoring system of a present invention includes a housing containing a plurality of pill dispensing compartments for dispensing medication to a patient at a desired time. The invention is programmed to dispense medication at the desired time and activates alarms if the proper procedure is not completed. The invention also contacts the emergency personnel through phone lines and initiates two-way hands free communication between the patient and emergency personnel. The invention further includes a pendent transmitter worn by the patient to contact emergency personnel.

Hultman, U.S. Pat. No. 5,582,593 describes an ambulatory medication delivery system which includes an ambulatory pump unit having a computer control linear motor pump for pumping predetermined volumes of fluid in accordance with a programmed delivery schedule which may be altered through communication with a remote monitoring location via a telephone data access line or via radio frequency communication. A clinician communication unit and a patient communication unit receive and send information to the ambulatory pump unit and also communicate via a telephone data modem access to the computer at a remote monitoring location at which trained health personnel can monitor a number of patient locations and alter or change medication delivery profiles as required.

Tacklind, U.S. Pat. No. 5,704,366 describes a system for monitoring and reporting medical information includes a stand-alone monitor for storing data records comprising measured values and time stamps and for transmitting the records to a remote reporting unit over a communication system. The remote reporting unit includes a relational data base that is updated when records are downloaded from the monitor; a report generator for generating chronological graphs of the measured values for a particular patient; and a report transmitting unit for transmitting reports to a requesting health care provider.

Ridgeway, U.S. Pat. No. 5,710,551 describes a system for the remote monitoring of in-home self-medication to assure compliance with prescribed dosage schedules. The system comprises at least one subscriber home medication station which interfaces with a communications link and a remote central monitoring station also interfaced with the link and operative to receive and analyze messages transmitted by the home medication station. The preferred home medication station embodiment transmits messages to the central station over the communications link each time the home medication station is accessed for a dosage of medication. Central station computer means verify receipt of such signals within each subscriber's uniquely scheduled dosage time windows, and alert an operator to take appropriate action if a dosage schedule error is detected. Alternative home medication station embodiments utilize a built-in programmable timer module to verify accessing of medication within a subscriber's uniquely scheduled dosage time windows, and to initiate transmission of alarm signals to the central station over the communications link if dosage schedule errors are detected by the timer module. All embodiments provide subscribers with help-button means to initiate transmission of alarm messages to the central station over the communications link in event of adverse reaction to medication, or other emergencies. Since the central station will be alerted if any scheduled dosage is missed, no emergency rendering a subscriber unable to press a help-button or call for help can go undetected longer than the maximum time between consecutively scheduled dosages.

Tacklind, U.S. Pat. No. 5,752,709 describes a system for monitoring and reporting medical information includes a stand-alone monitor for storing data records comprising measured values and time stamps and for transmitting the records to a remote reporting unit over a communication system. The remote reporting unit includes a relational data base that is updated when records are downloaded from the monitor; a report generator for generating chronological graphs of the measured values for a particular patient; and a report transmitting unit for transmitting reports to a requesting health care provider.

Stoop, U.S. Pat. No. 5,767,791 describes a two-way telemetry system which displays and monitors physiologic and other patient data of multiple, remotely located patients at a central location. The system comprises multiple battery-powered remote telemeters, each of which is worn by a respective patient, and a central station which receives, displays, and monitors the patient data received from the remote telemeter. The telemeters communicate with the central station using a two-way TDMA protocol which permits the time sharing of timeslots, and which uses a contention slot to permit telemeters to transmit service requests to the central station. Two-way special diversity is provided using only one antenna and one transceiver on each remote telemeter. The remote telemeters include circuitry for turning off the active transceiver components thereof when not in use (to conserve battery power), and include circuitry for performing a rapid, low-power frequency lock cycle upon power-up. The system has multiple modes of operation, including a frequency hopping (spread spectrum) mode and a fixed frequency mode, both of which preferably make use of the 902-928 MHz ISM band. Patient locators are provided to allow the clinician to track the location of each patient.

Russo, U.S. Pat. No. 5,807,336 describes a medical apparatus that is provided with a programmable medical device disposed at a first room location and a remote monitor and/or controller disposed at a second room location. The programmable medical device is used to administer a medical treatment to a patient, and the remote monitor/controller may be used to monitor the operation of the medical device, control the operation of the medical device, and/or transfer data from the medical device to the remote monitor/controller. The apparatus may allow voice communication between the remote monitor/controller and the patient who is receiving treatment via the medical device while the medical device is being monitored and/or controlled from the remote location. The remote monitor/controller may also include means for determining the type of medical device to which it is connected.

Brudny et al., U.S. Pat. No. 5,810,747 describes an interactive intervention training system used for monitoring a patient suffering from neurological disorders of movement or a subject seeking to improve skill performance and assisting their training. A patient (or trainee) station is used in interactive training. The patient (or trainee) station includes a computer. A supervisor station is used by, for example, a medical or other professional. The patient (or trainee) station and the supervisor station can communicate with each other, for example, over the Internet or over LAN. The patient (or trainee) station may be located remotely or locally with respect to the supervisor station. Sensors collect physiologic information and physical information from the patient or subject while the patient or subject is undergoing training. This information is provided to the supervisor station. It may be summarized and displayed to the patient/subject and/or the supervisor. The patient/subject and the supervisor can communicate with each other, for example, via video, in real time. An expert system and neural network determine a goal to be achieved during training. There may be more than one patient (or trainee) station, thus allowing the supervisor to supervise a number of patients/subjects concurrently.

The present invention fulfills an unmet need for a wide area network health maintenance system and provides further related advantages as described in the following summary.

### SUMMARY OF THE INVENTION

The present invention teaches certain benefits in construction and use which give rise to the objectives described below.

Family caregivers comprise the largest contingent of people caring for elderly persons. Without a doubt, family caregivers are dedicated and loving people. At times, however, the task of caring for an elderly family member becomes overwhelming. In addition, the demands of family and the workplace must be considered, along with the personal needs of the caregiver. The present invention is dedicated to helping family caregivers find that needed balance in their lives. The goals of the present invention are:

Provide family caregivers with information, resources, and support.

By using a CareGuide through an Internet service site www.carehelper.com, which will be described below, family caregivers can access information about legal and financial issues. The guide's Caregiving Skills Section provides information about caregiving tasks such as bathing and grooming, home and environmental safety assessment, medication compliance, and looking out for depression. A key component of CareGuide is the Caregiver Support Section, where family caregivers can find out about stress and its relief, and how to avoid the burnout so commonly associated with family caregiving. Each section of CareGuide provides links to informational and supportive resources available on other high-quality websites. We have pulled together the critical aspects of caregiving to provide a comprehensive Internet information base for family caregivers.

Provide family caregivers with the tools to organize their busy lives.

Users of the method of this invention will find a variety of resources designed to help alleviate stress through organization. By completing worksheets, caregivers are able to customize a personal care organizer in which all information related to care recipients' medical history, physicians, medications, pharmacies, food requirements and preferences, and insurance can be brought together in one place. Users also are provided with a calendar and personal planner to keep track of appointments and important events. A Shopping Manager allows caregivers to record needed medications, supplies, groceries and personal items. This list can be organized by store, and the caregiver can print it out when they plan to go shopping.

Provide Peace of Mind Through the Use of Remote Monitoring Technology.

Did Dad take his blood pressure medication? Will Mom remember to check her blood glucose? These are common worries among family caregivers. The invention method seeks to alleviate such worries through the introduction of remote monitoring medical devices. For example, Dad's blood pressure medication may be stored in CareHelper's pill bottle device. An alarm will sound at the time the medication is to be taken. If the bottle is opened, the device will transmit a signal to an in-home base station. This information is then uploaded to a database. The caregiver can request reports to track compliance, and can compare Dad's pill-taking behavior with his actual blood pressure as measured with a blood pressure device. Other devices remotely monitor devices to track blood glucose, weight, and body temperature.

Provide Feedback from Home Health Professionals.

In addition to reports that can be generated by the caregiver, the method utilizes computer video technology to generate periodic reports delivered by the care recipient's health care professional. These videotaped sessions take the caregiver through the reports step-by-step. They can be viewed at any time—even while the caregiver is at work.

Generally the embodiments described herein are examples of using the invention for healthcare applications. It should be noted, however, that the technology can just as easily be applied to applications outside of healthcare.

For example, the System could be used with a healthy consumer undergoing a diet and exercise program. The Data Collectors would measure body fat, calories burned, distance walked, and body weight. The shopping list would include diet bars and powders. A fitness consultant, rather than a nurse, would be the Video-star. The fitness consultant would recommend new exercises, provide encouragement and support, and suggest purchases of appropriate nutritional supplements. The End-User would use the Browser to receive this information, including Video Streams from the fitness consultant with selected synchronized charts.

In another example, the System could be used with a consumer looking to purchase cruise ship tickets or automobiles. The Data Collectors would include forms about their interest in different destinations or vehicle models. The Charts would include images of different destination, accommodations, vehicle features, and/or financing options for the trip or vehicle purchase.

In such a manner, the invention disclosed herein, which is based on technology previously disclosed, has application in many fields with health, fitness, diet, nutrition, travel, and consumer purchases.

Likewise, the invention has application in many forms of business-to-business relationships. For example, the System could be used by sale representatives for companies selling integrated circuits and electronic components to manufacturers of electronic devices. The Video-star would be the sales rep of the component provider. The End-User would be the purchasing agent of manufacturer. The Data Collection devices would include the manufacturer's inventory database system. The Video Stream would include data about needed components including Charts which illustrated products, showed graphical representations of inventory usage or status, and automatically generated purchase order forms for the End-User to approve.

In this manner, in all fields of business and commerce, the described invention offers a low-cost method by which status-reporting and sales-generating data can be deployed to the purchasers of products.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a diagram showing a login monitor screen of the preferred embodiment of the invention;

FIG. 2 is a diagram showing a new caregiver monitor screen thereof;

FIG. 3 is a diagram showing a caregiver page monitor screen thereof;

FIG. 4 is a diagram showing a caregiver personal information monitor screen thereof;

FIG. 5 is a diagram showing an add a new care recipient monitor screen thereof;

FIG. 6 is a diagram showing a care recipient personal information monitor screen thereof;

FIG. 7 is a diagram showing a care recipient emergency contact information monitor screen thereof;

FIG. 8 is a diagram showing a care recipient physician information monitor screen thereof;

FIG. 9 is a diagram showing a shopping manager monitor screen thereof;

FIGS. 10-12 are diagrams showing device set-up monitor screens thereof;

FIG. 13 is a flow chart of a CareHelper.com screens;

FIG. 14, is a diagram showing a testing for a video camera;

FIG. 15, is a diagram showing a screen for selecting reports for presentation;

FIG. 16, is a diagram showing a screen for selecting reports for presentation;

FIG. 17, is a diagram showing a screen for production of a video program; and

FIG. 18, is a diagram showing a screen for reviewing the video program and related charts.

### DETAILED DESCRIPTION OF THE INVENTION

The above described drawing figures illustrate the invention in at least one of its preferred embodiments, which is further defined in detail in the following description.

The Personalized Health Video System (the “System”) comprises one instance of a Healthcare Signal Telemetry System, which may be used for selling healthcare related products. Enhancements and modifications to the Healthcare Signal Telemetry System allow the same core technology to be used to sell numerous other types of products.

The complete System includes the following where “equipment” refers to hardware, software, as in computer coded instructions, systems interconnections and other means for achieving the stated method of the present method:

Personal data collecting devices (the “Data Collectors”) which may be:

Tangible products such as wave-energy enabled pill bottle lids previously disclosed, forms such as those that commonly appear on a computer screen for data entry, observational systems such as programs that monitor database or internet traffic for changes or information, other software enabled systems for determining personal data such as health care status, and other data entry methods, such as creation of shopping lists based upon item desired by the End-User.

Internet-enabled browser (the “Browser”) such as Microsoft Internet Explorer or Netscape Navigator or Mosaic. The Browser may include any internet-enabled viewing system for text, graphics or a combination of the two.

Information servers for database storage and manipulation “Database” such as Microsoft SQL Server.

Video servers for streaming video images and audio tracks (the “Video Stream”) such as Microsoft Media Server or Real Networks Video Server.

Internet servers “Internet Server” for sending html web pages and other formats of Browser-viewable pages over the internet.

Internet connections “Pipe” for linking Browser, Database, Video Stream and Internet Server with each other and with other Internet users. Preferably, the Pipe will have high-bandwidth such as a T1 line, cable modem or DSL. However, ordinary dial-up modems are sufficient too.

Server operating systems such as Windows NT or Unix “Server Operating System”. Depending upon the capabilities of the Server Operating System and the underlying hardware platform, the Database, Video Stream and Internet Servers may reside on the same machine or may reside on several machines that are linked with the Pipe or other linking means.

End-user operating systems such as Windows 95, Windows 98 or Windows NT. However, other operating systems such as Linux may also be used “User Operating System”.

Video cameras and microphones for creating custom videos that are commonly available. Preferably, the video cameras have parallel or USB connections to a personal computer. The microphone, preferably, links to a sound card or similar circuitry within the personal computer. However, the use of integrated camera/microphones and other formats of cameras and microphones may also be used. Collectively referred to herein as the “Camera”.

Personal computers, such as Pentium II and Pentium III based PCs that are commonly available with viewing monitors, keyboards, mouse, speakers and other typical accessories. Collectively referred to herein as the “PC”.

Specialized video creation software “Video Software” for generating custom videos, including controls for recording and setting camera/microphone functions. Such Video Software also replays videos after creation and compresses videos for distribution to others using the Video Stream.

Equipment for transferring data from Data Collectors to the Database. Such means may include the base-station device which receives the wave-energy signals from the Data Collectors and sends the corresponding information to the Database. The method of sending the information to the Database includes formatting it for transfer in the Pipe.

Equipment for creating graphical representations of data from the Database, typically in the form of time plots and charts. Preferably, multiple graphic representations are shown with axes synchronized for comparative viewing. The data in the Database may include data that is transferred from the Data Collectors. It may also include data that is received from other sources, such as a catalog of products and their affiliated purposes. It may further include data that is received from other sources which describes a process or series of steps to perform to accomplish a goal. Any and all such graphical representations are referred to as the “Charts”.

Equipment for accessing and graphically viewing pictures of products or illustrations of tangible items or illustrations of process-oriented steps, as may be stored on the Database. An example of such a process are the steps necessary to prepare a meal, including making a list of items to procure, preparing the items for cooking, instructions for cooking times, and illustrations of serving suggestions. Any and all such graphical representations are also referred to as the “Charts”.

Audio sound pickup equipment for receiving sounds from the audio tracks of the Video Streams.

Video equipment for viewing moving pictures from the Video Streams.

Equipment for determining personalized information from the Database as may apply specifically to one end-user.

Equipment for selecting graphical images (items #14 and 13) and placing them in a list for later selection in random or sequential or repetitive order.

Equipment for creating the video in a window on the screen while selecting the graphical images from the list. Such images appearing in an adjacent window in sync with the video message mentioning or describing such graphical image.

Definitions of different types of system users:

The “End-User” is a consumer or patient or family caregiver. Typically, this person would be a customer for the business deploying the System.

The “Video-star” is a person who represents the business (or its affiliated or related interests) and is using the System. Typically, this person would be a nurse who is advising the patient or the family caregiver about some aspect of healthcare. However, this person could also be a sales representative selling health-related products, such as wheelchairs, or other non-health-related products, such as flowers.

Equipment for automatically creating a relationship between the personalized information about the End-User and the graphical images generated from the Database and the text format data from the Database. Then further equipment for displaying a text or visual message that cues the Video-star to mention appropriate portions of the personalized information in sync with selecting the Charts.

Equipment for automatically generating a script or list of points for the Video-star to mention. Such equipment includes running pre-defined rules on the database to identify End-Users who are likely to benefit from such information. For example, the pre-defined rule might be “remind any End-User taking medications to get a refill if the Data Collector equipment indicates that 30 days have passed in which the medication was taken”. Please note: this rule differs from a simple 30-day reminder to get a refill (current state-of-the-art) because it counts the number of days in which the medication was actually taken (one of our advances of the state-of-the-art).

Equipment for automatically generating Charts, such as a shopping list or purchasing order form. Such generated charts are created based upon running pre-defined rules on the database.

Equipment for allowing the Video-star to review the Charts and personalized information and then take notes for items to mention to the End-User in a video presentations consisting of the Video Stream and synchronized Chart displays.

Equipment for allowing the Video-star to review the Charts and personalized information and then prepare notes to be displayed to the End-User in a video presentations consisting of the Video Stream and synchronized Chart displays. One or more such Charts would include the display of notes just created by the Video-star.

Equipment for generating information that is of temporal use to the End-User, including presentation of such information in text, graphical or video formats. Such temporal information may be in the form of “Alerts” or “Suggestions”. The Alerts might include information about a data parameter that was out of range. The Suggestions might include purchasing suggestions for upcoming holidays. These Alerts and Suggestions are displayed to the End-User. These Alerts and Suggestions are also displayed to the Video-star prior to creation of a Video Stream. The Alerts and Suggestions are one form of the automatically generated scripting information.

Many custom prepared videos with associated and synchronized chart presentations can be made using commonly available software such as Microsoft Netshow or Real Networks RealPresenter. However, the drawbacks of these products include an inability to link directly to databases, a time-consuming and expensive method of preparation and delivery, and an inability to randomly select charts while in the midst of creating the video. Also, these products lack the ability to automatically generate scripts for the person creating the video. All these limitations are addressed with the current inventions described herein.

The specification of the present invention includes an example of the System in which a Nurse is monitoring a care-recipient at home. Since most care-recipients are elderly, the Nurse often, but not always, communicates with a family caregiver such as an adult child living in the same home. With respect to terminology, the Nurse is the “Video-star”. The term “Nurse” also includes other clinician and non-clinical persons who might assist with the care of the End-User. The term “System” is also referred to as CareHelper.com, which is the web-enabled platform upon which the embodiment of the technology has been built.

The care-recipient and family caregiver are aggregated to be the “End-User”. The Nurse Station is the PC workstation that a Nurse uses to access a the Database and create the Video Stream.

The Base-Station Hardware and Software runs on the End-User computer and allows the “Data Collector” devices (pill bottle, blood pressure monitors, etc.) to link to the “Database”. The Browser also allows the End-User to create, view, access, modify and otherwise interact with a Shopping List Manager. This is another form of a Data Collector in which information is collected from the End-User regarding personal shopping habits or desires.

The “Alerts” window which appears on the End-User homepage functions to notify the End-User of temporal items. The Suggestions and Reminders window which appears on the Shopping Manager screen and End-User homepage functions to notify the End-User of purchasing suggestions or reminders.

The Alerts, Suggestions, Reminders, Shopping List information, Database information, and Charts formed from the Database information all appear on the Nurse Workstation Screens. The Nurse is able to select any or all of these items, in any order including repeating any such item, while creating the Video Stream. These are then saved, compressed and displayed to the End-User in sync with the video message.

Such Video Stream message includes health status information, reminders to make purchases, reassurance, rapport-generating statements, educational information, and/or other information or commentary as may be deemed advisable by the Nurse. Sample of such video commentary were previously disclosed in the above-mentioned patent applications.

The present invention is a personalized health video system, method and apparatus which comprises a personal data collecting means, Internet enablement equipment, information system, video serving equipment, server operating system, user operating system, graphical creation equipment, viewing equipment, audio equipment, relationship generating equipment, script generating equipment, charts generating equipment, chart reviewing equipment, and video library equipment; the components arranged and interconnected and enabled in an operating personalized health video system.

The method of the invention presents personalized video programming to medical patients. The method is functional through a data processing system referred to above as the information system, and comprising, for each selected patient, the steps of: receiving a medical alert message responsive to a trigger action; reviewing patient specific data corresponding to the alert message; forming a medical decision based upon the patient data; selecting non-patient specific information relative to the patient data and the medical decision; composing a video program based on the patient specific data and the non-patient specific information; encoding, posting and hosting the video program; creating the posting; logging the video program; transmitting the video program to the selected patient; and enabling playback of the video program for patient review and follow-up. The trigger action is performed by at least one of; a medical personnel, the selected patient, and a computer program. The patient specific data is usually requested by the medical personnel and includes patient vital signs and patient medical performance actions and other information.

To accomplish the above method, the medical information system comprises patient specific data collecting devices, software enabling distributive network communications, a data storing equipment, a video streaming equipment, video show producing equipment, network data transmission equipment, video show playback equipment, and patient specific data. The video show producing equipment is preferably an equipment for producing a graphical image show of selected and sequenced images. An equipment for simultaneous video displaying of the graphical image show, and related written commentary is preferably provided. As well, an equipment for creating a stored relationship between the patient specific data and a graphical image show is provided.

An equipment for producing graphical representations of the patient specific data is enabled, as well as a equipment for associating non-patient specific information in the graphical representations of the patient specific data. An equipment for creating a script for a video show is provided. An automation equipment for creating video charts related to a patient specific data.

The method of the present invention comprises the use of a variety of computer monitor screens which provide enablement for placing information into and retrieving information from storage as well as the functions described above. The set of screens described below define the present method and apparatus of the invention as follows:

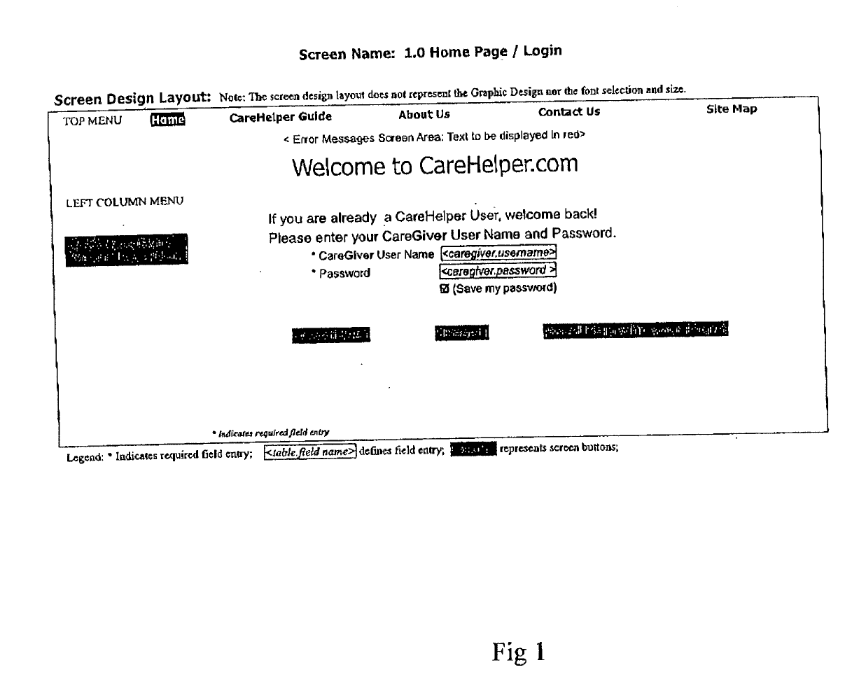

FIG. 1 shows a monitor screen of the present invention designed as an introduction. Pertinent to this screen are the following:

Screen Title: CareHelper Home Page. Display “Welcome to CareHelper.com”

Screen Design: TBD

Screen Goal: Present overview of business, services and products and also gather the minimum amount of information needed in order to login the CareGiver.

Design approach: Intended to be user friendly, intuitive with personalized instructions and greetings.

Screen Access: Initial page display when visiting web site: CareHelper.com and when selecting Home Page

Screen Top Menu Bar: CareHelper Top Menu Bar

Screen Left Column Menu Bar: Blank

Table Access: 1) Caregiver Table (Read)

Screen Defaults: Display saved User name and saved password as “****” if Saved Password field was checked.

Required Fields: See indicator * by the fields for required field entry for successful processing.

Screen Buttons:

Continue—will process screen info

Reset—will clear fields and reset to defaults

New Member Registration—will go to Screen Name: 2.0 New Member Registration

[Need help with your Login and Password]—will go to a screen to make it possible for CareHelper to email to the user their correct User Name and Password

Special Processing:

When first displaying window fields: If Saved Password is checked default the password and display ‘****’. If Saved Password is not checked do not default the display of the password.

Screen Processing:

[Continue] key processing: Confirm Password′ field with User login.

If a match, continue to the CareGiver Page

If not valid, display the following error message:

“Your Password is not valid, please reenter your password.”

If you need help with your login, please select [need help with login and password]

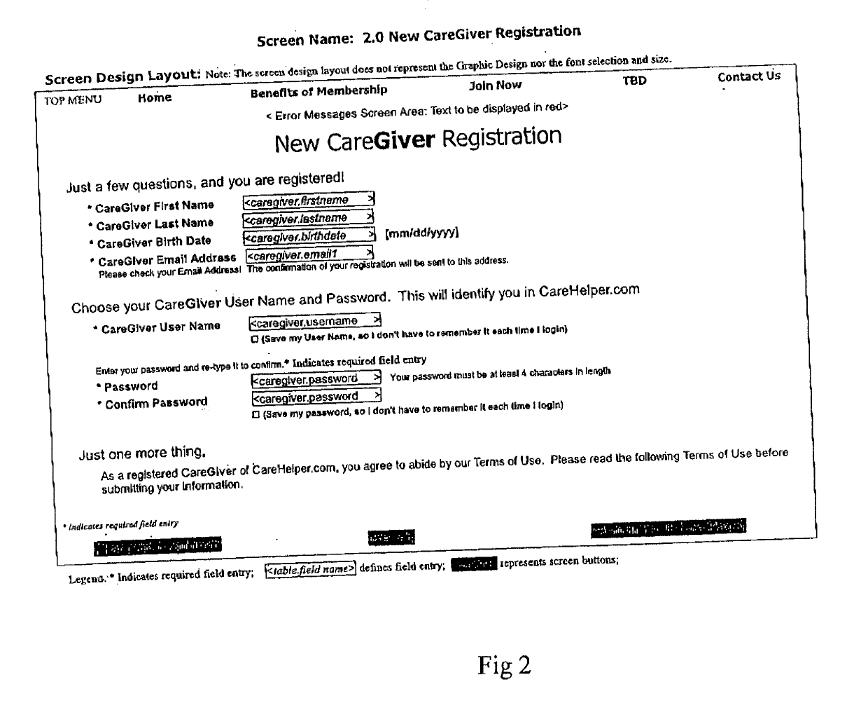

FIG. 2 shows a monitor screen of the present invention designed for registration of the patient. Pertinent to this screen are the following:

Screen Title: New CareGiver Registration (display title: Note special font bolding of “Giver”)

Screen Design: Template was based on the membership registration screen practices that are commonly used on other websites.

Screen Goal: Gather the minimum amount of information needed in order to register the CareGiver. Also, to appear consistent with other website registration processes as are in common usage today.

Design approach: Intended to be user friendly, intuitive with personalized instructions and greetings.

Screen Issues:

Screen Access: From CareHelper Home Page

Screen Top Menu Bar: New Caregiver Registration Top Menu Bar—navigates with drop down lists.

Screen Left Column Menu Bar: Blank

Table Access: 1) Caregiver Table (Read/Write)

Screen Defaults: none

Required Fields: See screen for required fields for successful registration.

Screen Buttons: I Accept; Reset; Return to Home Page; Continue

Special Processing:

Highlight all require fields which have not been completed in red.

Only show ‘*’ for each character enter into the password and confirm password fields.

Save Username and redisplay on login screen, each time user logs in.

If “save password” is selected, default the saved password on the login screen.

Process after the selection of the [I accept/Submit form] key:

Verify ‘CareGiver First and Last Name’ combined, are a unique entry.

‘Confirm Password’ field must match the ‘Password’ field entry. If fields do not match, clear both fields and request the user to reenter the password with the message:

“Your Confirmed Password does not match your Password, please reenter your password”.

Restrict Password to be a minimum of 4 characters.

Screen processing:

[I accept Submit Form]: After successful registration processing:

Display a clear screen with the Top Menu Bar and display the following statement in the <error messages and message screen area>:

“Welcome, <caregiver.firstname> as a registered CareGiver with CareHelper.com”

Display the buttons Continue and Return to CareHelper Home Page.

[Reset form]: The Reset Form key will clear all fields on the screen and place the cursor back at the top of the screen.

Unsuccessful registration: After selecting the [I accept/Submit form] key, reject the registration for the following reasons and display the following statement in the <error messages and message screen area>:

“We were unable to register you as a CareGiver with CareHelper, because you are already a registered CareGiver”

“Password cannot be less than 4 characters. Please try again”

“We were unable to register you as a CareGiver with CareHelper.com. Please complete entry for the following fields” (highlight the fields in Red)

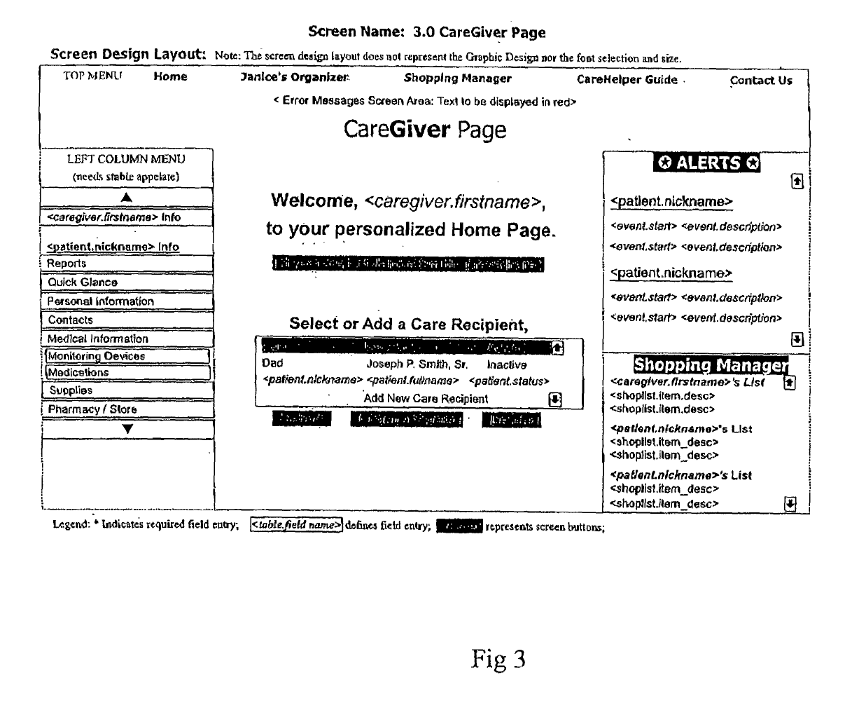

FIG. 3 shows a monitor screen of the present invention designed for use by the caregiver. Pertinent to this screen are the following:

Screen Title: CareGiver Page (display title)

Screen Design:

Allow a CareGiver to have more than one Care Recipient, initially two but no limit.

Have important patient specific alerts presented to the CareGiver for immediate follow up.

Easily see the Care Recipient information options available on the Left Column Menu Bar.

The Top Menu bar was designed to assist the CareGiver manage their day, time, personal items, mail, account and help coordinate multiple Care Recipients.

Screen Goal: With minimum effort, CareGiver can quickly see priority patient follow up items, still access their calendar and personal info and easily access the navigational menu bar to quickly get to the patient specific information.

Design approach: Intended to be user friendly, intuitive with personalized instructions and greetings.

Issues/Concerns:

Top Menu Bar: Caregiver Recipient Top Menu Bar (drop down selection)

Left Column Menu Bar: 1) CareGiver Page Left Column Menu Bar (Shift menu navigation); 2) CareGiver—Care Recipient Left Menu Bar

Right Column Frame: Alert events, in a scroll box. Alerts by patient. Shopping Manager frame.

Table Access: 1) Caregiver Table (Read), 2) Patient Table (Read), 3) Events (Read)

Screen Buttons: If you are not <caregiver.firstname> <caregiver.lastname>, press here; Select, Change Status, Delete

Screen Defaults:

Default the first patient in the CareGiver list of patients as selected when the window is first displayed and no prior Care Recipients have been selected.

Display the defaulted patient's nicknames in the Left Column Menu Bar. If no nicknames exist for the Care Recipient, display the <patient.firstname> instead.

If a CareGiver has no Care Recipients entered, then:

Do not display a Care Recipients Nickname on the Left Column Menu Bar

Display an empty Alert Box on the Right Column Frame

Display the Shopping Manager box if empty (ie. could have CareGiver only shopping items if no Care Recipient has been entered.

Only display CareGiver Page Left Menu Bar, do not display Care Recipient Left Menu Bar

Only Display the buttons: [If you are not <caregiver.firstname> <caregiver.lastname>, press here]

Required Fields: na

Special Processing:

If a Care Recipient for the Registered CareGiver has already been selected then each time they return to this page display the Care Recipient Nickname on the Left Column Menu Bar. (Default to Care Recipient first name, if there is no nickname)

Display all of the Care Recipients and their associated Alert events for a CareGiver in the Alert scrolling box.

Screen Processing:

After the Care Recipient has been highlighted and selected access the Care Recipient from the Patient Table, return to the CareGiver Page, display the <patient.nickname> over the Left Column Menu Bar. Display the buttons associated with more than one patient.

After the New Care Recipient has been highlighted and selected go directly to the Add Care Recipient screen and display cleared fields ready for entry.

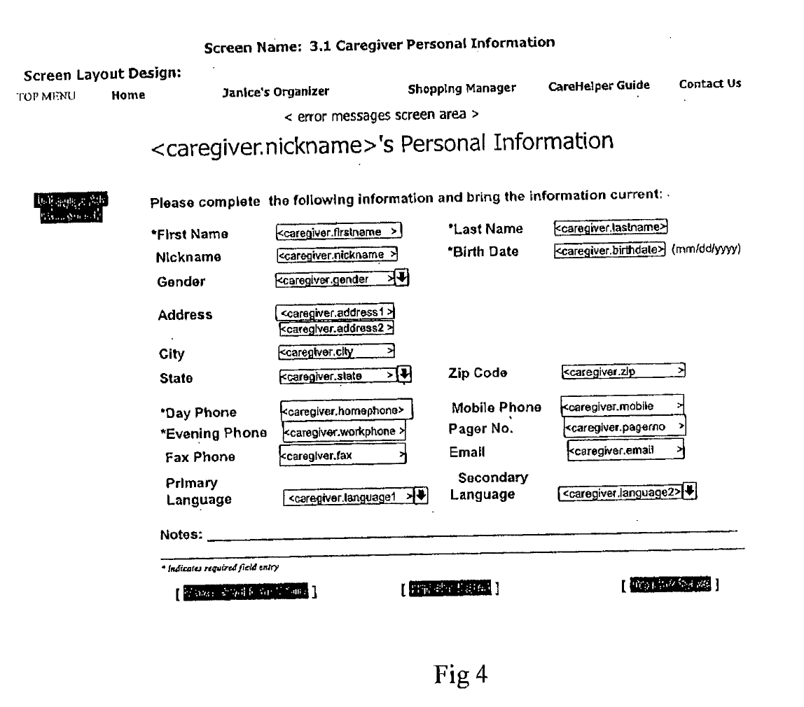

FIG. 4 shows a monitor screen of the present invention designed for documenting personal information of the caregiver. Pertinent to this screen are the following:

Screen Title: CareGiver Information (display title with CareGiver First name to personalize the window)

Screen Design: Formatted similar to other system screens, where information that is logically grouped and placed on single screens. The user is still allowed to exit the screen without changing information. Screen layout still needs to be finalized.

Screen Goal: Allow a CareGiver to enter a minimum set of information.

Design approach: Intended to be user friendly, intuitive with personalized instructions and greetings.

Screen Access: CareGiver Page-Recipient Left Bar Menu; Directly from the New CareGiver Information [Continue] Key

Top Menu Bar: CareGiver Page Top menu Bar

Left Column Menu Bar: [Change Password] access

Table Access: 1) Caregiver Table (Read)

Required Fields: see screen for identified fields with *

Default Fields: If no nickname is added, default first name for nickname.

Drop Down Box: State field is selected through a drop down box, first letter typed and go directly to that position in the list

Screen processing:

Following the [Save and Continue] key selection, save the entered information into the CareGiver Table and go to the next sequence screen.

Following the [Return Later] key selection, save the entered information into the CareGiver Table and return to CareGiver Page 3.0

Following the [Do not save] key selection, do not save the entered information and return to CareGiver Page 3.0.

[Change My Password] will display a pop-up screen to allow the password to be changed and confirmed. After the password has been changed update the CareGiver Table and send an email to the CareGiver confirming the new password.

If the user tries to leave the screen without selecting one of the three button, give an error message “xxxxxxx”

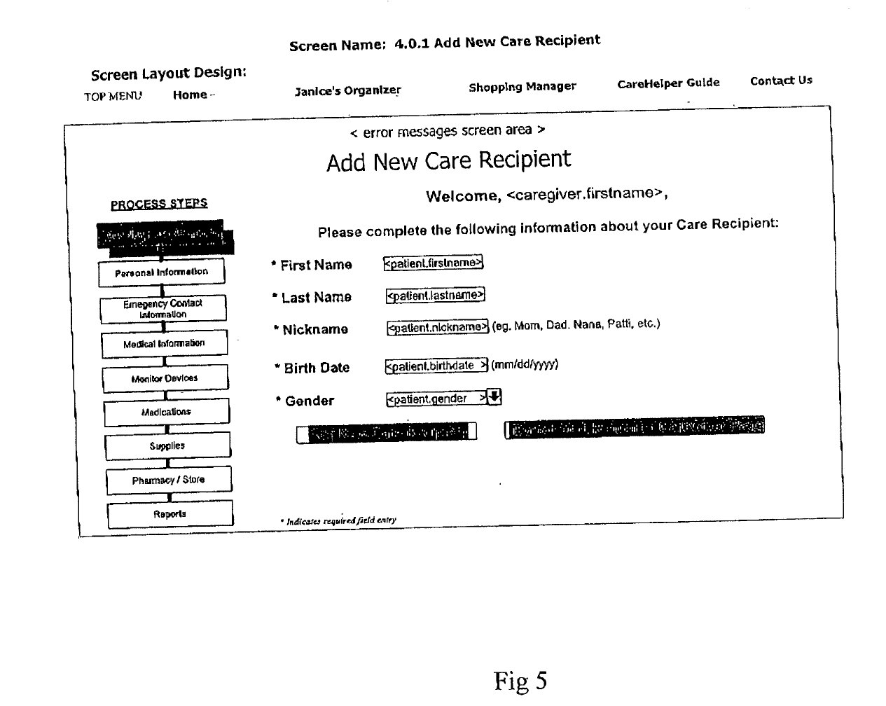

FIG. 5 shows a monitor screen of the present invention designed for adding a new care recipient. Pertinent to this screen are the following:

Screen Title: Add New Care Recipient

Screen Design: Formatted similar to other system screens, to have information easily entered and still allow the user to exit the screen without adding a Care Recipient.

Screen Goal: Allow a CareGiver to enter a minimum set of information, in order to add a Care Recipient

Design approach: Intended to be user friendly, intuitive with personalized instructions and greetings.

Top Menu Bar: Caregiver Top menu Bar

Left Column Menu Bar: Process Steps

Table Access: 1) Caregiver Table (Read), 2) Patient Table (Write)

Required Fields: see screen for identified fields

Screen processing:

Following the [Add New Care Recipient] key selection, and a successful processing, add the information to the Patient Table and go to the Care Recipient Information Screen.

If Care Recipient Firstname is the same as CareGiver Firstname, display a message to recommend a nickname.

Unsuccessful add: After selecting the [Add New Recipient] key, reject the add for the following reasons and display the message at the bottom of the screen:

“We were unable to add the Care Recipient, because the person already exists in the CareHelper.com.”

“We were unable to add the Care Recipient. Please complete entry for the following fields: List the fields.”

Following the [Do not add, Return to CareGiver Page] key selection, return to the CareGiver Page

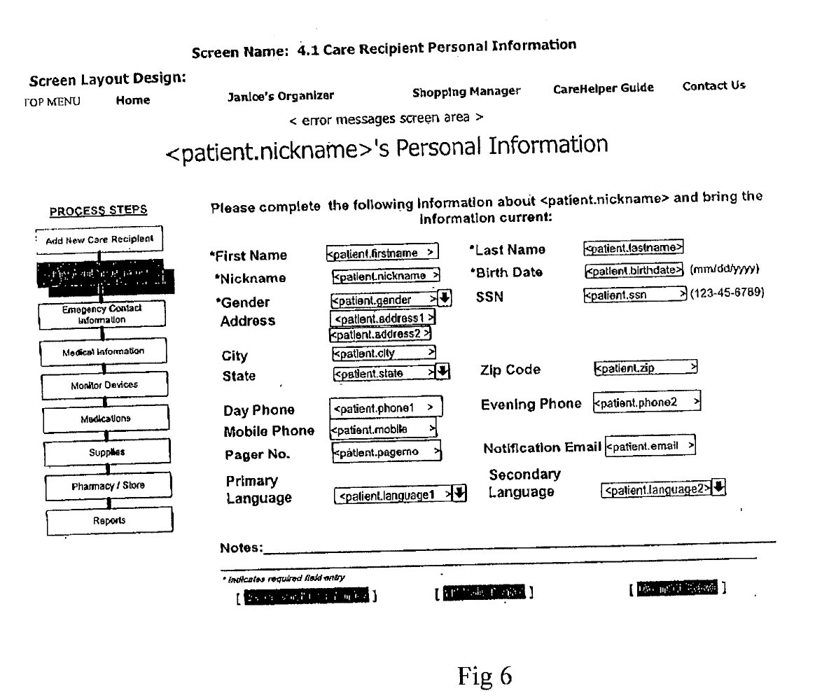

FIG. 6 shows a monitor screen of the present invention designed for documenting a care recipient person information. Pertinent to this screen are the following:

Screen Title: Care Recipient Information (display title with Care Recipient First name to personalize the window)

Screen Design: Formatted similar to other system screens, where information that is logical grouped is placed on single screens. The user is still allowed to exit the screen without changing information. Screen layout still needs to be finalized.

Screen Goal: Allow a CareGiver to enter a minimum set of information.

Design approach: Intended to be user friendly, intuitive with personalized instructions and greetings.

Screen Access: CareGiver Page-Recipient Left Bar Menu; Directly from the New Care Recipient Information [Continue] Key

Top Menu Bar: Caregiver Page Top menu Bar

Left Column Menu Bar: 1) CareGiver Page Left Column Menu Bar; 2) CareGiver—Care Recipient Left Menu Bar

Table Access: 1) Caregiver Table (Read), 2) Patient Table (Write),

Required Fields: see screen for identified fields

Default Fields: If no nickname is added, default first name for nickname.

Drop Down Box: State field is selected through a drop down box, first letter typed and go directly to that position in the list

Screen processing:

Display the information that has been previously entered for a New Care Recipient and for an existing Care Recipient. Allow the information to be updated.

Following the [Save and Continue] key selection, save the entered information into the Patient Table and go to the next sequence screen.

Following the [Return Later] key selection, save the entered information into the Patient Table and return to CareGiver Page.

Following the [Do not save] key selection, do not save the entered information and return to CareGiver Page.

If the user tries to leave the screen without selecting one of the three button, give an error message “xxxxxxx”

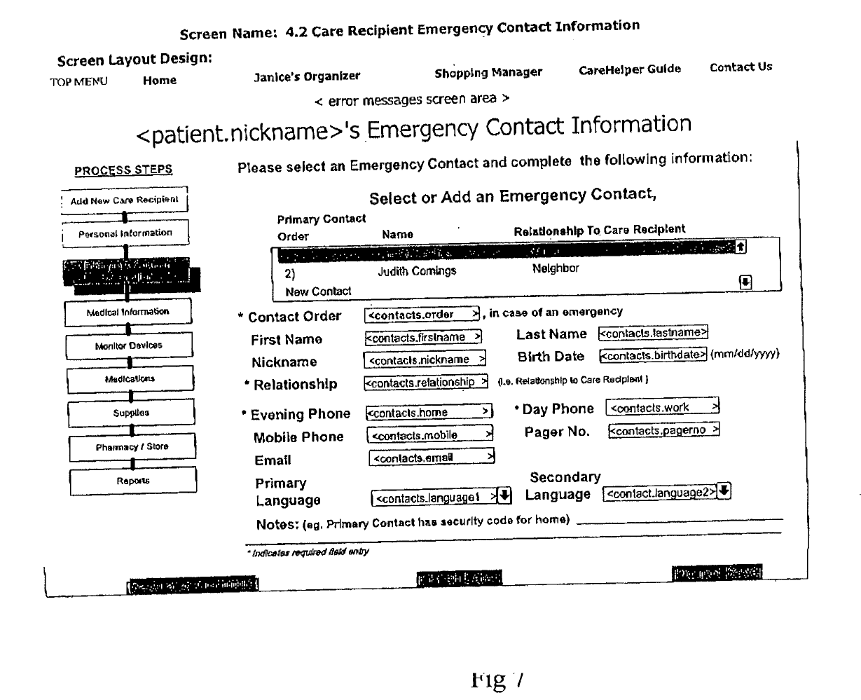

FIG. 7 shows a monitor screen of the present invention designed for documenting a care recipient's personal information. Pertinent to this screen are the following:

Screen Title: Care Recipient Contact Information (display title with Care Recipient First name to personalize the window)

Screen Design: Formatted similar to other system screens, where information that is logical grouped is placed on single screens. The user is still allowed to exit the screen without changing information.

Screen Goal: Allow a CareGiver to enter a minimum set of information.

Design approach: Intended to be user friendly, intuitive with personalized instructions and greetings.

Screen Access: CareGiver Page-Recipient Left Bar Menu; Directly from the Care Recipient Personal Information [Continue] Key

Top Menu Bar: Caregiver Page Top menu Bar

Left Column Menu Bar: 1) CareGiver Page Left Column Menu Bar; 2) CareGiver—Care Recipient Left Menu Bar

Table Access: 1) Caregiver Table (Read), 2) Patient Table (Read), 3) Patient Contacts Table

Required Fields: see screen for identified fields

Default Fields: If no nickname is added, default first name for nickname. Default the CareGiver as the Primary Emergency Contact and allow update of the contact order.

Drop Down Box: “Contact Order” are selected through a drop down box, first letter/number typed and go directly to that position in the list. See Tables Definition in the Appendix for field Drop Down Box values

Screen processing:

When initially displaying window,

Default the primary contact with the Care Giver info if no contact has been entered.

If “New Contact” is highlighted and display the fields ready for a new contact Add

Default to highlighting the one contact in the select box (Care Giver is no other has been entered), and default the display of the contact in the fields

If more than one contact exists, display the contacts in the select box in Contact order, default to the last contact updated/entered and highlight and display in fields

Following the [Save and Continue] key selection, save the entered information into the Contacts Table and go to the next sequence screen.

Following the [Return Later] key selection, save the entered information into the Contacts Table and return to CareGiver Page.

Following the [Do not save] key selection, do not save the entered information and return to CareGiver Page.

If the user tries to leave the screen without selecting one of the three button, give an error message “xxxxxxx”

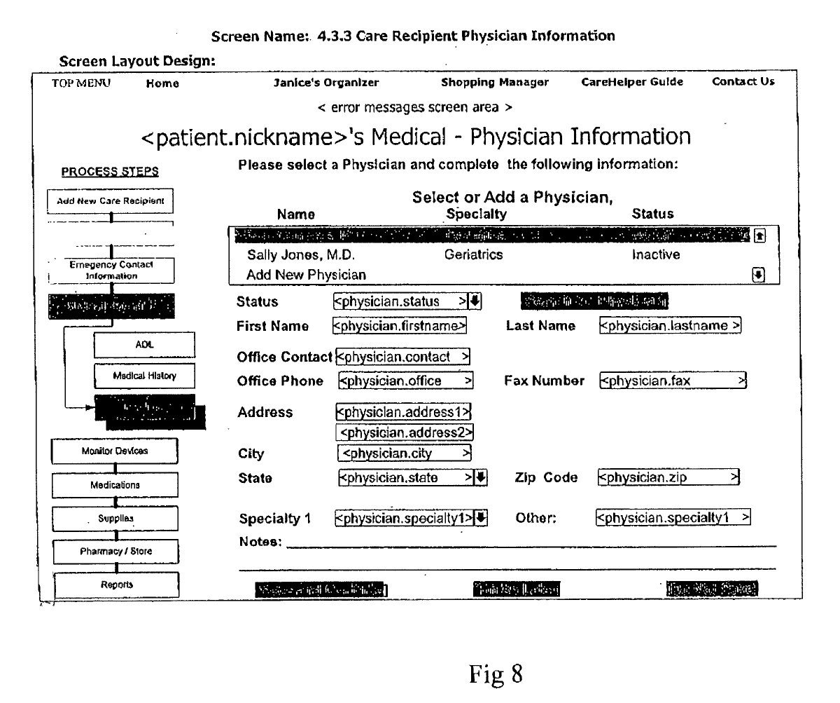

FIG. 8 shows a monitor screen of the present invention designed for documenting a care recipient's physician information. Pertinent to this screen are the following:

Screen Title: Care Recipient Medical—Physician Information (display title with Care Recipient First name to personalize the window)

Screen Design: Formatted similar to other system screens, where information that is logical grouped is placed on single screens. The user is still allowed to exit the screen without changing information.

Screen Goal: Allow a CareGiver to enter a minimum set of information.

Design approach: Intended to be user friendly, intuitive with personalized instructions and greetings.

Screen Access: CareGiver Page—Recipient Left Bar Menu; Directly from the Care Recipient Contact1 Information [Continue] Key

Top Menu Bar: Caregiver Page Top menu Bar

Left Column Menu Bar: 1) CareGiver Page Left Column Menu Bar; 2) CareGiver—Care Recipient Left Menu Bar

Table Access: 1) Caregiver Table (Read), 2) Patient Table (Read), 3) Patient Physician Table

Required Fields: see screen for identified fields

Default Fields: If no nickname is added, default first name for nickname.

Drop Down Box: “Status”, “Specialty 1” and “State” fields are selected through a drop down box, first letter typed and go directly to that position in the list. See Tables Definition in the Appendix for field Drop Down Box values

Screen processing:

When initially displaying window,

If there are no physicians entered, default to highlighting the “New Physician” and display the fields ready for a new physician Add.

If there is only one physician entered, default to highlighting the one contact in the select box, and default the display of the physician in the fields

If more than one physician exists, display the physician in the select box in physician order, default to the last contact updated/entered and highlight and display in fields

[Search for Physician] button goes to the Search Physician search function, which searches a list of predefined physicians

Following the [Save and Continue] key selection, save the entered information into the physician table and go to the next sequence screen.

Following the [Return Later] key selection, save the entered information into the physician Table and return to CareGiver Page.

Following the [Do not save] key selection, do not save the entered information and return to CareGiver Page.

If the user tries to leave the screen without selecting one of the three button, give an error message “xxxxxxx”

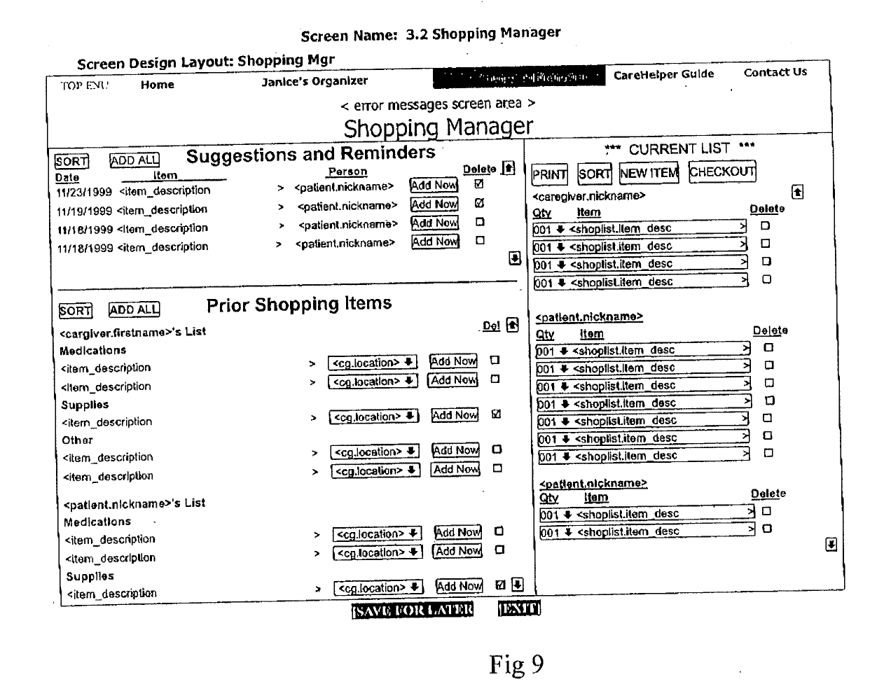

FIG. 9 shows a monitor screen of the present invention designed for managing health care shopping. Pertinent to this screen are the following:

Screen Title: Shopping Manager (display title)

Screen Design:

Screen Goal:

Design approach: Intended to be user friendly, intuitive with personalized instructions and greetings.

Top Menu Bar: Caregiver Page Top menu Bar

Left Column Menu Bar: Shopping Manager Left Menu Bar

Table Access: 1) Caregiver Table (Read), 2) Patient Table (Read) 3) Shopping Manager

Required Fields: n/a

Default Fields: n/a

Drop Down Box: n/a

Buttons: RESET; SAVE; EXIT; PRINT; CLEAR ALL; NEW ITEM

Screen processing:

Load the entire default Shopping Manager Prior Lists into the main center window

Load the Suggestions and Reminders in the Suggestions area and sort by Person by Item

Display the Current List items selected To-Date and corresponding quantities

First time entering the window, display the Shopping Manager sorted by Caregiver list, Patient list. Within each list sort by Medications, Supplies and Other and within each subcategory sort by item.

Button Processing:

[Save for Later] saves the screen for later use and processes any of the screen check-offs for removing (delete) from any indicated lists.

[EXIT] exits without saving any of the changes or any additional processing

[RESET] Clears and resets the current shopping list.

[New Item] Displays a pop up window with a new item to add to the current list window

[Print] prints the current list

[Add All to List] adds every item in the current box to current list with a default “001” quantity.

[CHECK OUT]—prints the current list; clears and resets the current shopping list.

Display item CG location and allow drop down box changes. If Change Location is selected in the drop down box, go to a new window (pop box) to process the change location for the item. Allow to add a new location if needed.

In the current list window, the item is allowed to have zero quantity and still remain on the list until it is refreshed, then the item is deleted. Allow changing the number of items from 0-999.

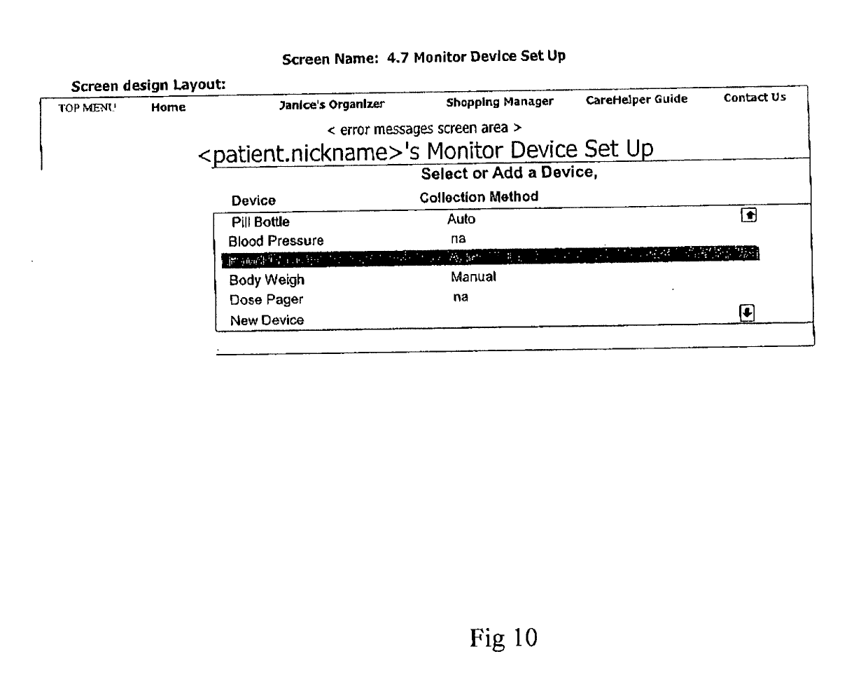

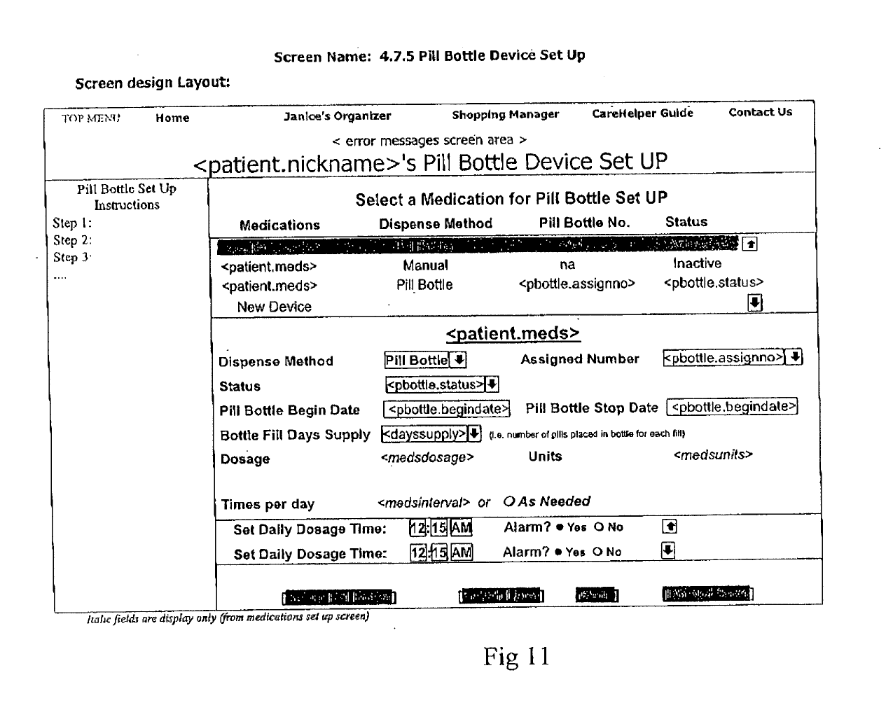

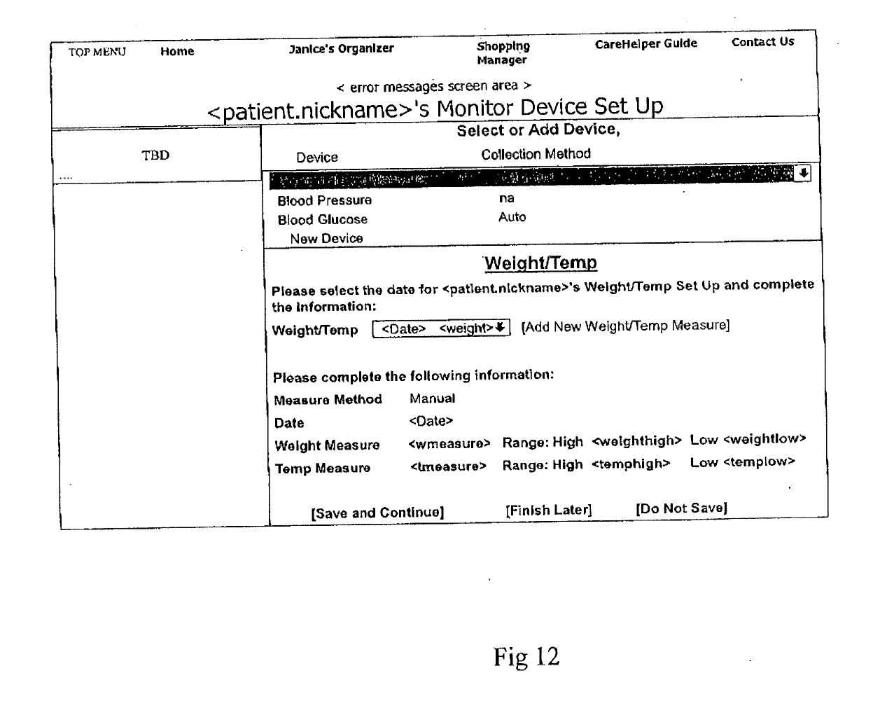

FIGS. 10-12 show monitor screens of the present invention designed for device set-up.

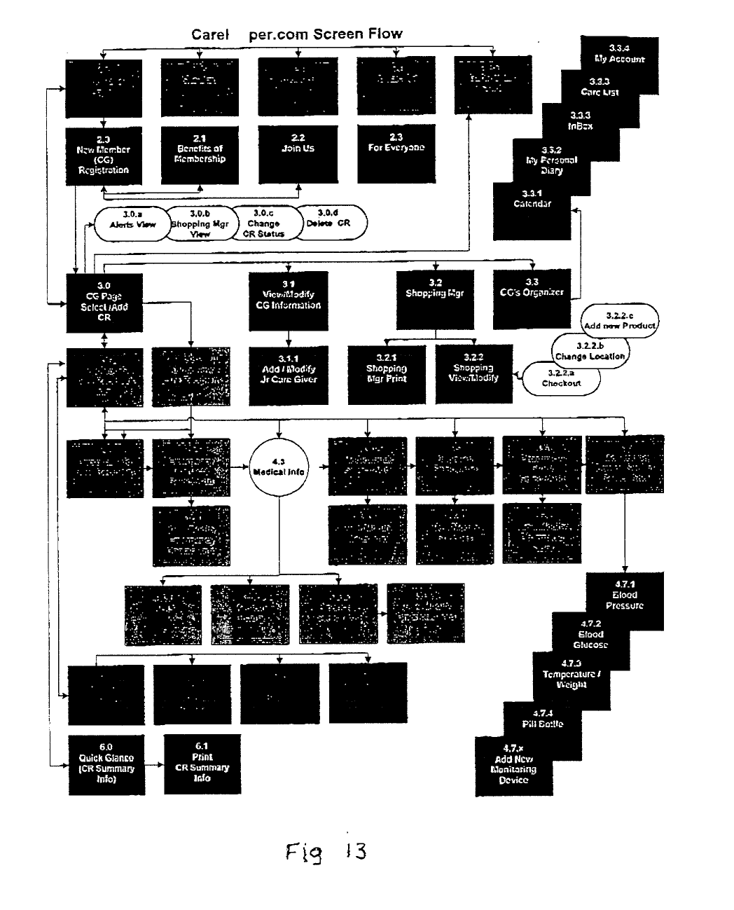

FIG. 13 is a screen flow diagram of CareHelper.com and defines the options available to the user.

A Nurse Station of the invention operates in three steps as follows:

1. Prepare to make the video

1.1 Test Camera

1.2 Select CareGiver and Care Recipient

1.3 Select Reports for Presentation

2. Make the Video/Presentation

2.1 Make the Video

3. Review Video/Presentation and Submit

3.1 Review Video and selected Reports

As above, we define the method and apparatus of this portion of the invention by defining the monitor video screens used, as follows:

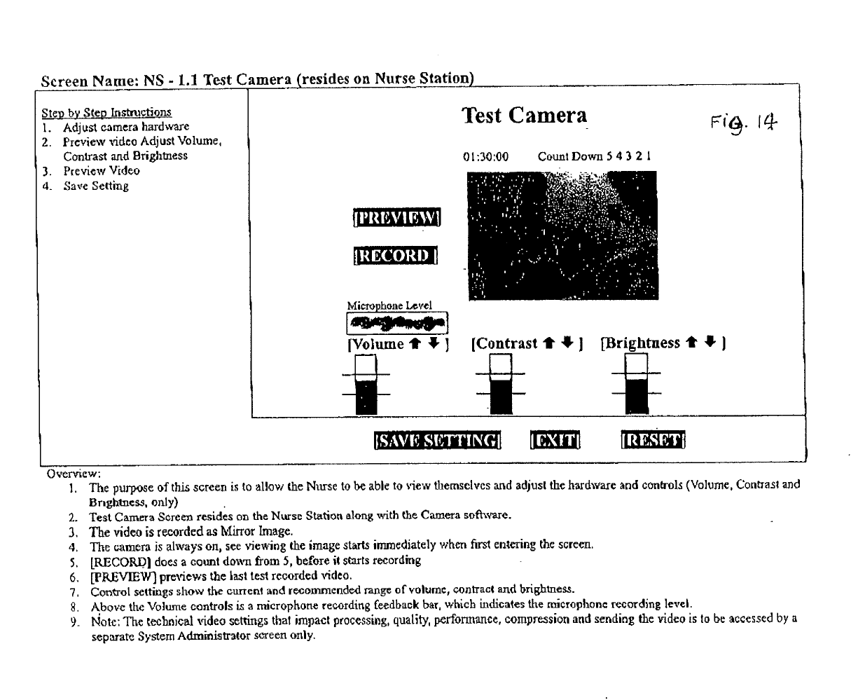

Referring now to FIG. 14, for testing the video camera:

1. The purpose of this screen is to allow the Nurse to be able to view themselves and adjust the hardware and controls (Volume, Contrast and Brightness, only)

2. Test Camera Screen resides on the Nurse Station along with the Camera software.

3. The video is recorded as Mirror Image.

4. The camera is always on, see viewing the image starts immediately when first entering the screen.

5. [RECORD] does a count down from 5, before it starts recording

6. [PREVIEW] previews the last test recorded video.

7. Control settings show the current and recommended range of volume, contract and brightness.

8. Above the Volume controls is a microphone recording feedback bar, which indicates the microphone recording level.

9. Note: The technical video settings that impact processing, quality, performance, compression and sending the video is to be accessed by a separate System Administrator screen only.

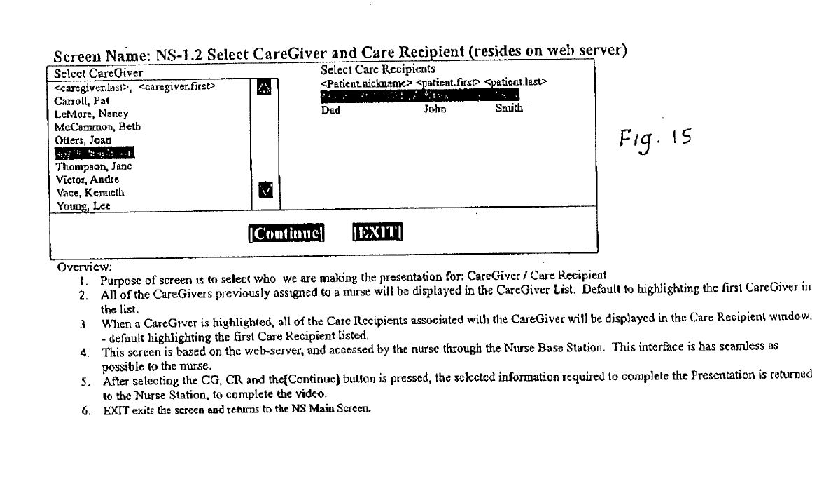

Referring now to FIG. 15, for selecting reports for presentation:

1. Purpose of screen is to select who we are making the presentation for: CareGiver/Care Recipient (also referred to as “CG” and “CR”, respectively).

2. All of the CareGivers previously assigned to a nurse will be displayed in the CareGiver List. Default to highlighting the first CareGiver in the list.

3. When a CareGiver is highlighted, all of the Care Recipients associated with the CareGiver will be displayed in the Care Recipient window.—default highlighting the first Care Recipient listed.

4. This screen is based on the web-server, and accessed by the nurse through the Nurse Base Station. This interface is has seamless as possible to the nurse.

5. After selecting the CG, CR and the [Continue] button is pressed, the selected information required to complete the Presentation is returned to the Nurse Station, to complete the video.

6. EXIT exits the screen and returns to the NS Main Screen.

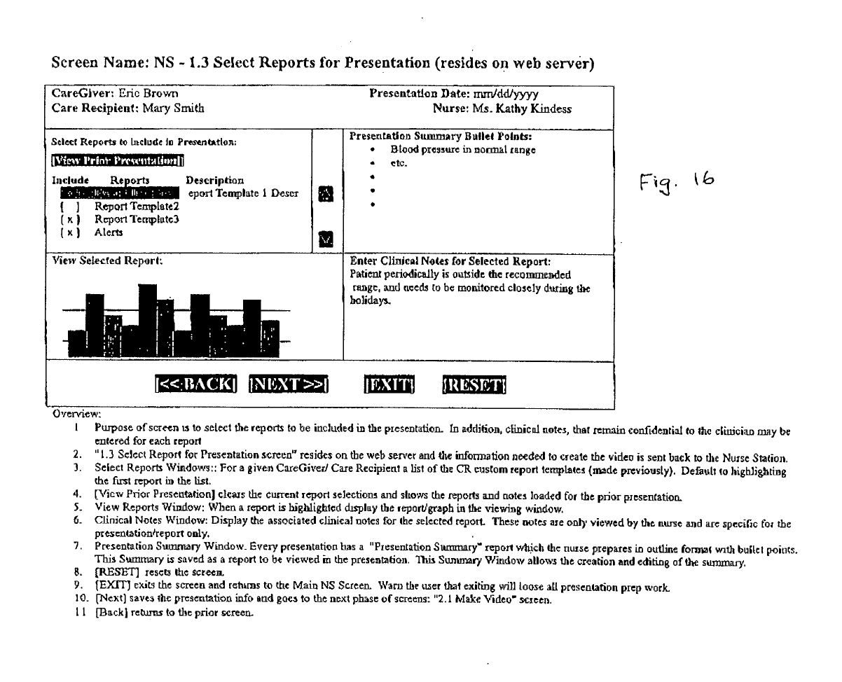

Referring now to FIG. 16, for selecting reports for presentation:

1. Purpose of screen is to select the reports to be included in the presentation. In addition, clinical notes, that remain confidential to the clinician may be entered for each report

2. “1.3 Select Report for Presentation screen” resides on the web server and the information needed to create the video is sent back to the Nurse Station.

3. Select Reports Windows:: For a given CareGiver/Care Recipient a list of the CR custom report templates (made previously). Default to highlighting the first report in the list.

4. [View Prior Presentation] clears the current report selections and shows the reports and notes loaded for the prior presentation.

5. View Reports Window: When a report is highlighted display the report/graph in the viewing window.

6. Clinical Notes Window: Display the associated clinical notes for the selected report. These notes are only viewed by the nurse and are specific for the presentation/report only.

7. Presentation Summary Window: Every presentation has a “Presentation Summary” report which the nurse prepares in outline format with bullet points. This Summary is saved as a report to be viewed in the presentation. This Summary Window allows the creation and editing of the summary.

8. [RESET] resets the screen.

9. [EXIT] exits the screen and returns to the Main NS Screen. Warn the user that exiting will loose all presentation prep work.

10. [Next] saves the presentation info and goes to the next phase of screens: “2.1 Make Video” screen.

11. [Back] returns to the prior screen.

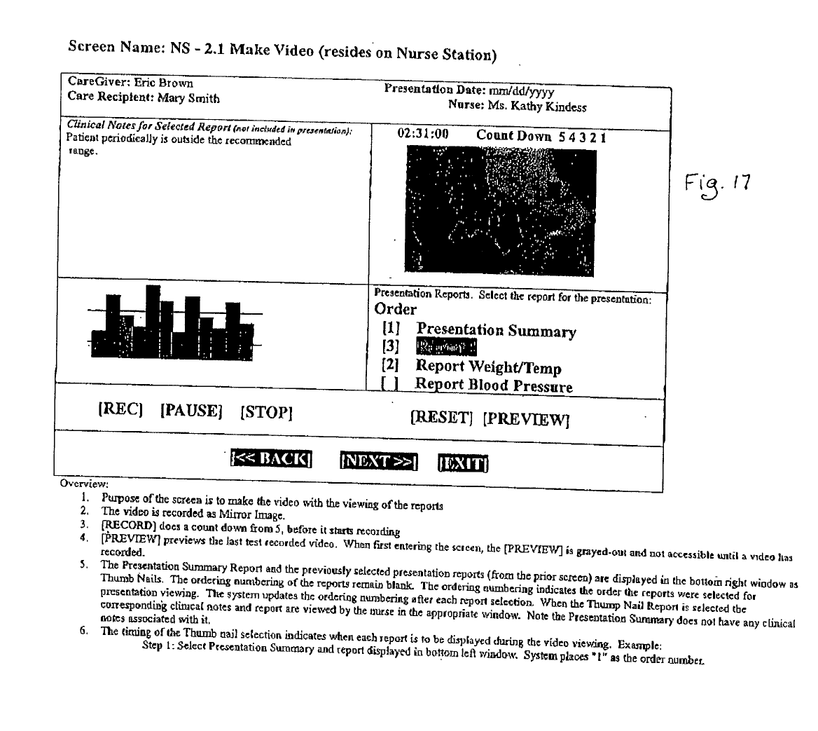

Referring now to FIG. 17, for production of the video:

1. Purpose of the screen is to make the video with the viewing of the reports

2. The video is recorded as Mirror Image.

3. [RECORD] does a count down from 5, before it starts recording

4. [PREVIEW] previews the last test recorded video. When first entering the screen, the [PREVIEW] is grayed-out and not accessible until a video has recorded.

5. The Presentation Summary Report and the previously selected presentation reports (from the prior screen) are displayed in the bottom right window as Thumb Nails. The ordering numbering of the reports remain blank. The ordering numbering indicates the order the reports were selected for presentation viewing. The system updates the ordering numbering after each report selection. When the Thumb Nail Report is selected the corresponding clinical notes and report are viewed by the nurse in the appropriate window. Note the Presentation Summary does not have any clinical notes associated with it.

6. The timing of the Thumb nail selection indicates when each report is to be displayed during the video viewing, Example:

Step 1: Select Presentation Summary and report displayed in bottom left window. System places “1” as the order number

Step 2: Press [Rec], and the video starts recording.

Step 3: Select Report Weight Temp, report loads while video is still recording. Step 4: The nurse provides commentary or other information associated with the report being displayed.

Step 5: The nurse repeats steps 3 and 4 for additional reports. At a later time during the video, the nurse may return to any of the reports for further follow-up commentary.

Step 6: When complete, the nurse presses the “Stop” button.

7. The REC, PAUSE and STOP buttons visually look like the buttons on a video player.

8. The [BACK] button allows the Nurse to go back to the previous page and make changes if necessary and return to continue the video from this page, if the video has been paused.

9. [Pause] button pauses the video recording but does not interfere with selecting and loading of reports. Re-pressing the [Pause] will continue the video recording

10. [STOP] stops the video recording and completes the video. Once the video has been [STOP] stopped, it cannot be modified.

11. EXIT exits the screen and returns to NS Main Screen. Warn the user that exiting will loose all presentation prep work.

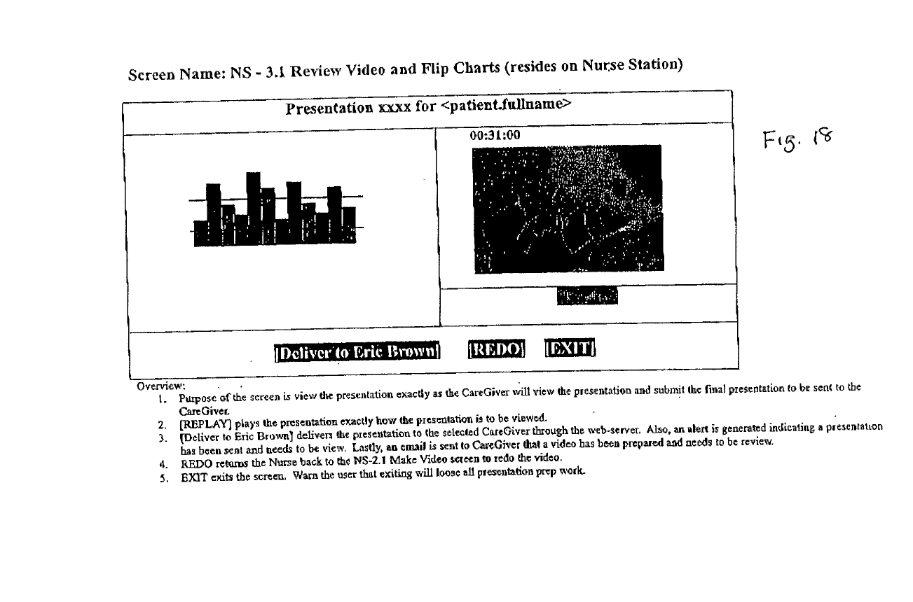

Referring now to FIG. 18, to review the video and charts:

1. Purpose of the screen is view the presentation exactly as the CareGiver will view the presentation and submit the final presentation to be sent to the CareGiver.

2. [REPLAY] plays the presentation exactly how the presentation is to be viewed.

3. [Deliver to <caregiver.firstname> <caregiver.lastname>] delivers the presentation to the selected CareGiver through the web-server. Also, an alert is generated indicating a presentation has been sent and needs to be view. Lastly, an email is sent to CareGiver that a video has been prepared and needs to be review.

4. REDO returns the Nurse back to the NS-2.1 Make Video screen to redo the video.

5. EXIT exits the screen. Warn the user that exiting will loose all presentation prep work.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A personalized health video system, method and apparatus which comprises: the components of, a personal data collecting means, Internet enablement means, information system, video serving means, server operating system, user operating system, graphical creation means, viewing means, audio means, relationship generating means, script generating means, charts generating means, chart reviewing means, and video library means; the components arranged and interconnected and enabled in an operating personalized health video system.

2. A method for presenting personalized video programming for the purpose of selling medical supplies, the method functional through a data processing system, and comprising, for each of a plurality of selected patients, the steps of: reviewing patient specific data relevant to a selected patient; forming a medical appraisal concerning the supply needs of the selected patient based upon the patient specific data; forming a sales oriented communication objective; composing a video program based on the sales communication objective; posting and hosting the video program; enabling playback of the video program; and enabling follow-up actions motivated by the video program.

3. The method of claim 2 further comprising the step of enabling a trigger action performed by at least one of; a medical personnel, the selected patient, and a computer program, the trigger action motivating the step of reviewing of the patient specific data.

4. The method of claim 3 wherein the patient specific data is requested by the medical professional.

5. The method of claim 2 wherein the patient specific data includes patient vital signs and patient medical performance.

6. A medical information system comprising: patient specific data collecting devices; software enabling distributive network communications; a data storing means; a video streaming means; video show producing means; network data transmitting means; video show playback means; and patient specific data.

7. The system of claim 6 wherein the video show producing means is enabling for producing a graphical image show of selected and sequenced images.

8. The system of claim 7 further comprising means for simultaneous video displaying of the graphical image show, and related written commentary.

9. The system of claim 7 further comprising means for creating a stored relationship between the patient specific data and a graphical image show.

10. The system of claim 7 further comprising means for producing graphical representations of the patient specific data.

11. The system of claim 10 further comprising means for associating non-patient specific information in the graphical representations of the patient specific data.

12. The system of claim 6 further comprising means for creating a script for a video show.

13. The system of claim 6 further comprising automation means for creating video charts related to a patient specific data.

14. The system of claim 6 further comprising system and show editing means.

15. A personalized health video system apparatus which comprises: a personal data collecting means, Internet operations enabling means, information storing system, video serving means, server operating system, user operating system, graphics creating means, viewing means, audio producing means, relationship generating means, script generating means, charts generating means, chart reviewing means, and video library using means; the components arranged and interconnected and enabled in an operating personalized health video system.
